(19) United States
(12) Patent Application Publication
(10) Pub. No.: US 2016/0309569 A1
(43) Pub. Date: Oct. 20, 2016

(54) INTELLIGENT LIGHTING CONTROL SYSTEM FOR WORKPLACES

(71) Applicant: SRIKANTH RANGINENI, NELLORE (IN)

(72) Inventor: SRIKANTH RANGINENI, NELLORE (IN)

(21) Appl. No.: 15/101,417

(22) PCT Filed: Dec. 7, 2014
(86) PCT No.: PCT/IN2014/050003

§ 371 Date: Jun. 3, 2016

(30) Foreign Application Priority Data
Dec. 9, 2013 (IN) 5674/CHE/2013

(51) Int. Cl. H05B 37/02; G05B 15/02

(52) U.S. Cl. CPC H05B 37/0272; H05B 37/0227; H05B 37/0281; G05B 15/02

(57) ABSTRACT

In one implementation, a control system (100) and method thereof for controlling one or more controllable devices is disclosed. The control system (100) comprises of a first means (102) and a second means. The first means detects active or inactive event on one or more electronic or electrical device; and detects one or more electronic or electrical device's transition between of an active or inactive states. The second means controls one or more controllable device, based on at least one of active or inactive event detected on one or more electronic or electrical device and one or more electronic or electrical device's transition between at least one of an active or inactive states detected. The system turns on the lights (corresponding to user's computer terminal) when Active event takes place on the user's computer and turns off the lights when Inactive event takes place on the user's computer.

### TECHNICAL FIELD

The present subject matter described herein, in general, relates to a field of control system, and more particularly to a control system and method thereof for activity based control of variety of devices or systems.

### BACKGROUND

In workplaces, there will be numerous instances when a user has to stay away from his computer terminal to attend other activities. When user is no longer sitting in his workplace, the light corresponding to his computer terminal can be turned off to save power. Currently, this is widely accomplished using occupancy/motion sensors.

Occasionally, when people have to move away from their workplaces, they will Lock their computer or turn it off or put it in Sleep or Hibernate modes or any other semi active or inactive or low power states. Whenever people are moving away from their workplace they may have to manually switch off the nearby devices or systems that may include but not limited to lighting systems, HVAC systems like AC systems but not limited to them, and any other electronic or electrical equipment. This involves manual intervention and hence is time consuming process. Further, many times people may ignore or forget to switch off or turn off the nearby devices and systems which ultimately results in a sufficient amount of electricity and power wastage.

Computer controlled lighting systems wherein a set of lights will be turned on/off at scheduled time and the ability to turn on/off lights through keys/buttons in computers, smart phones and tablets is quite popular these days. In case, if user's computer allows controlling lights and other similar devices corresponding to his workplace, he can turn off the light through keys/buttons on his computer before leaving his computer terminal.

The present invention relates broadly to a control system to save power in workplaces where users work on computers or any other equipment without the necessity of occupancy/motion sensors. In workplaces that have a large number of employees, apart from giving intended power savings, present invention results in significant savings in cost of occupancy/motion sensors and other power losses from any unintended triggering of the occupancy/motion sensors.

### SUMMARY OF THE INVENTION

The following presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

In one aspect the present invention provides a control system to save power in workplaces where users work on computers or any other equipment without the necessity of occupancy/motion sensors. In workplaces that have a large number of employees, apart from giving intended power savings, the present control system results in significant savings in cost of occupancy/motion sensors and other power losses from any unintended triggering of the occupancy/motion sensors.

In another aspect the present invention provides a system wherein, whenever a computer or any other equipment to be monitored is turned off or put in Sleep or Hibernate mode or when user Locks the computer or any other equipment to be monitored, a message is sent to the server or lighting controller connected to the user computer or any other equipment to be monitored (either through any wireless/wired mechanism) to turn off the lights or any other system or device that is controlled corresponding to the user's computer terminal or any other equipment to be monitored.

In another aspect the present invention provides a system wherein, whenever user Log in or Unlocks his computer or any other equipment to be monitored then a message is sent to the server or lighting controller connected to the user computer or any other equipment to be monitored (either through any wireless/wired mechanism) to turn on the lights or any other system or device that is controlled corresponding to the user's computer terminal or any other equipment to be monitored.

In another aspect, the present invention provides a system wherein, it avoids using keys/buttons on the computer every time to turn on/off the lights and other similar devices. Hence, by automatically controlling the working of devices the present invention saves substantial amount of time and power.

In another aspect, the present invention turns on the lights or/and other similar devices that are controlled (corresponding to user's computer terminal or/and other similar devices) when Active (or active) event takes place on the user's computer and turns off the lights or/and other similar devices that are controlled when Inactive (or inactive) event takes place on the user's computer or any other equipment to be monitored.

Accordingly, in one implementation, a control system (100) for controlling one or more controllable devices is disclosed. The control system (100) comprises of a first means (102) and a second means. The first means may be configured for detecting at least one of active or inactive event on one or more device wherein the device may include at least one electronic or electrical or electrical device; and for detecting one or more device's transition between at least one of an active or inactive states. The second means (104) may be configured for controlling one or more controllable device, based on at least one of active or inactive event detected on one or more electronic or electrical device and one or more electronic or electrical/electrical device's transition between at least one of an active or inactive states detected.

In one implementation, a control system (100) for controlling one or more controllable devices is disclosed. The control system (100) comprises of a memory (206) for storing a plurality of instructions and a processor (202) operatively coupled to the memory (206). The processor (202) is configured to: detect at least one of active or inactive event on one or more electronic or electrical device (208); and one or more electronic or electrical device's transition between at least one of an active or inactive states (210); and to control (212) one or more controllable device, based on at least one of active or inactive event detected on one or more electronic or electrical device and one or more electronic or electrical device's transition between at least one of an active or inactive states detected.

In one implementation, a method for controlling one or more controllable device, based on at least one of active or inactive event detected on one or more electronic or electrical device and one or more electronic or electrical device's transition between at least one of an active or inactive states is disclosed.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE ACCOMPANYING DRAWINGS

The above and other aspects, features, and advantages of certain exemplary embodiments of the present invention will be more apparent from the following description taken in conjunction with the accompanying drawings in which:

FIG. 1 illustrates a control system with a first means and a second means for controlling one or more controllable devices as shown, in accordance with an embodiment of the present subject matter.

FIG. 2 illustrates a control system with processor, an interface and a memory for controlling one or more controllable devices as shown, in accordance with an embodiment of the present subject matter.

FIG. 3 illustrates a computer/group of computers that share one or more lights in workplace wherein active events happen on the user computer and lights corresponding to the user computer are tuned on as shown, in accordance with an embodiment of the present subject matter.

FIG. 4 illustrates a computer/group of computers that share one or more lights in workplace wherein inactive events happen on the user computer and lights corresponding to the user computer are tuned off as shown, in accordance with an embodiment of the present subject matter.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

### DETAILED DESCRIPTION OF THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

The present invention describes a system wherein when people have to move away from their workplaces, they will Lock their computer or turn it off or put it in Sleep or Hibernate mode or any other semi active or inactive or low power states. Instead separately turning off the lights every time by using any switch or through any keys/buttons on the computer, the proposed invention discusses a system wherein, whenever a computer is turned off or put in Sleep or Hibernate mode or when user Locks the computer or any other semi active or inactive or low power states on the computer, automatically a message is sent to the server or a controller connected to the user computer (either through any wireless/wired mechanism) to turn off the lights and other similar devices corresponding to the user's computer terminal and other similar devices. Similarly, whenever, user turns ON or wakes up, Log in or Unlocks his computer then a message is sent to the server or lighting controller connected to the user computer (either through wireless/wired mechanism) to turn on the lights and other similar devices corresponding to the user's computer terminal and other similar devices.

The present system turns on the lights and other similar devices (corresponding to user's computer terminal) when Active event takes place on the user's computer and turns off the lights and other similar devices when Inactive event takes place on the user's computer.

While aspects of described control system and method thereof for activity based control of variety of devices or systems may be implemented in any number of different computing systems, environments, and/or configurations, the embodiments are described in the context of the following exemplary system.

Another embodiment of the present invention describes a lighting control system to save power in workplaces where users work on computers without the necessity of occupancy/motion sensors. In workplaces that have a large number of employees, apart from giving intended power savings, this new lighting control system results in significant savings in cost of occupancy/motion sensors and other power losses from any unintended triggering of the occupancy/motion sensors.

In the present invention, occurrence of one or more of the following events on the user's computer is regarded as an Active (or active) event (may be pre-defined) but may not be limited to these:
1. Computer Unlock (User session is Unlocked)
2. User “Log in” into the computer
3. Computer (or electronic or electrical device) wakes up from Sleep or Hibernate state or any other low power state defined by Advanced Configuration and Power Interface (ACPI) specification or any other semi/inactive/low power states
4. Computer Turned on

In the present invention, occurrence of one or more of the following events (may be pre-defined) on the user's computer is regarded as an Inactive (or inactive) event but may not be limited to these:
1. Computer Lock (User session is Locked)
2. User session is “Log off”
3. Computer (or electronic or electrical device) enters into Sleep or Hibernate or any other low power state defined by Advanced Configuration and Power Interface (ACPI) specification state or any other semi/inactive/low power states
4. Computer “Shutdown”/Turned off

In one embodiment, the techniques not only consider above mentioned events, but further may consider emotional activity causing some event within that area, and provide lighting geared toward or otherwise appropriate for such specific event. In some embodiments, the physical activity causing the event may be divided into general activity and specific activity; emotional activity may be subdivided in a similar fashion, with each type of activity causing light to be adjusted, turned off or turned on in a particular way. Other factors may be considered as well, including the layout of the area being illuminated and/or any user provided lighting preferences or learned preferences. In some embodiments, user preferences can be used to override general physical and/or emotional activity, and specific physical and/or emotional activity can override the user preferences. Further, the event can be generated from a key stroke on keyboard, pressing a mouse button, a mouse movement etc. It can also be generated from use of devices connected to the user computer. Numerous variations and lighting systems will be apparent in light of this disclosure.

When Active event happens or occurs, the computer or the device that is to be monitored is said to be in Active state. Similarly, when Inactive event happens the computer is said to be in Inactive state.

In one implementation, instead of performing two operations viz., turn on/off the lights and/or similar devices though keys/buttons on user's computer and execute above mentioned active/inactive events, with a single operation i.e., when above mentioned active/inactive events happen, both the computer and lighting systems (and/or similar devices) are controlled simultaneously. This lessens the user efforts and saves time.

In one implementation, when user may not voluntarily invoke Inactive events while moving away from the computer terminal. There may be Power management and/or display control programs installed on the computer that automatically invokes Inactive events and take the computer to Inactive state as per the scheduled plan. Also, some workplaces employ mechanisms that take the computers or the device to be monitored into Inactive state at the scheduled predefined time (e.g. automatically turning off all systems after work hours). The present invention controls the lighting based on the Active/Inactive events and computer's transition between Active or inactive states irrespective of whether the Active/Inactive events and state change is caused by the user or through any automatic scheduled activity.

In one embodiment, when the computer is in Inactive state and any user activity is detected on the computer, the light may be turned on for a predetermined amount of time. For e.g. if user is trying to Unlock or Log in into the computer the light can be turned On immediately after user presses any key instead of waiting for the computer to Unlock. However, if user fails to Unlock or Log in into the computer, the light is turned off after the expiry of predetermined amount of idle time as the system is still in Inactive state.

The methodology and techniques described with respect to the present invention may be performed using a machine or other computing device within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a smart phone, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The machine may include a processor e.g., a central processing unit (CPU), a graphics processing unit (GPU, or both), a main memory and a static memory which communicate with each other via a bus. The machine may further include a video display unit (e.g., a liquid crystal displays (LCD), a flat panel, a solid state display, or a cathode ray tube (CRT)). The machine may include an input device (e.g., a keyboard) or touch-sensitive screen, a cursor control device (e.g., a mouse), a disk drive unit, a signal generation device (e.g., a speaker or remote control) and a network interface device.

The disk drive unit may include a machine-readable medium on which is stored one or more sets of instructions (e.g., software) embodying any one or more of the methodologies or functions described herein, including those methods illustrated above. The instructions may also reside, completely or at least partially, within the main memory, the static memory, and/or within the processor during execution thereof by the machine. The main memory and the processor also may constitute machine-readable media.

The present disclosure contemplates a machine readable medium containing instructions, or that which receives and executes instructions from a propagated signal so that a device connected to a network environment can send or receive voice, video or data, and to communicate over the network using the instructions. The instructions may further be transmitted or received over a network via the network interface device.

While the machine-readable medium can be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: tangible media; solid-state memories such as a memory card or other package that houses one or more read-only (non-volatile) memories, random access memories, or other re-writable (volatile) memories; magneto-optical or optical medium such as a disk or tape; non-transitory mediums or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

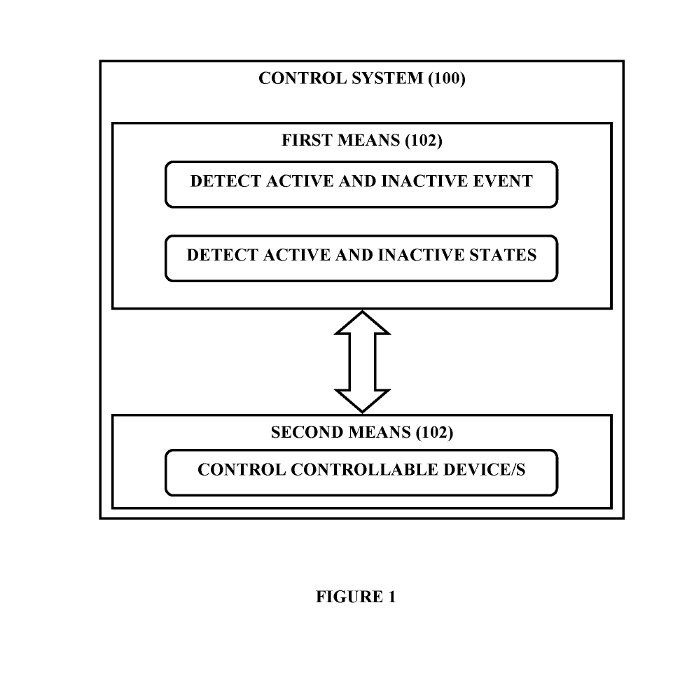

Referring now to FIG. 1, illustrates a control system (100) with a first means (102) and a second means (104) for controlling one or more controllable devices as shown, in accordance with an embodiment of the present subject matter.

In one implementation, a control system (100) for controlling one or more controllable devices is disclosed. The control system (100) comprises of a first means (102) and a second means. The first means may be configured for detecting at least one of active or inactive event on one or more electronic or electrical device; and for detecting one or more electronic or electrical device's transition between at least one of an active or inactive states. It may be understood by the person skilled in the art that the first mean for detecting may be any available detectors or any specialized computer program for detecting events and the like mechanisms. In one example, the computer itself detects the events and states. The second means (104) may be configured for controlling one or more controllable device, based on at least one of active or inactive event detected on one or more electronic or electrical device and one or more electronic or electrical device's transition between at least one of an active or inactive states detected. It may be understood by the person skilled in the art that the second means may be a controller or a specialized device that be available for controlling the other devices, but not limited to it.

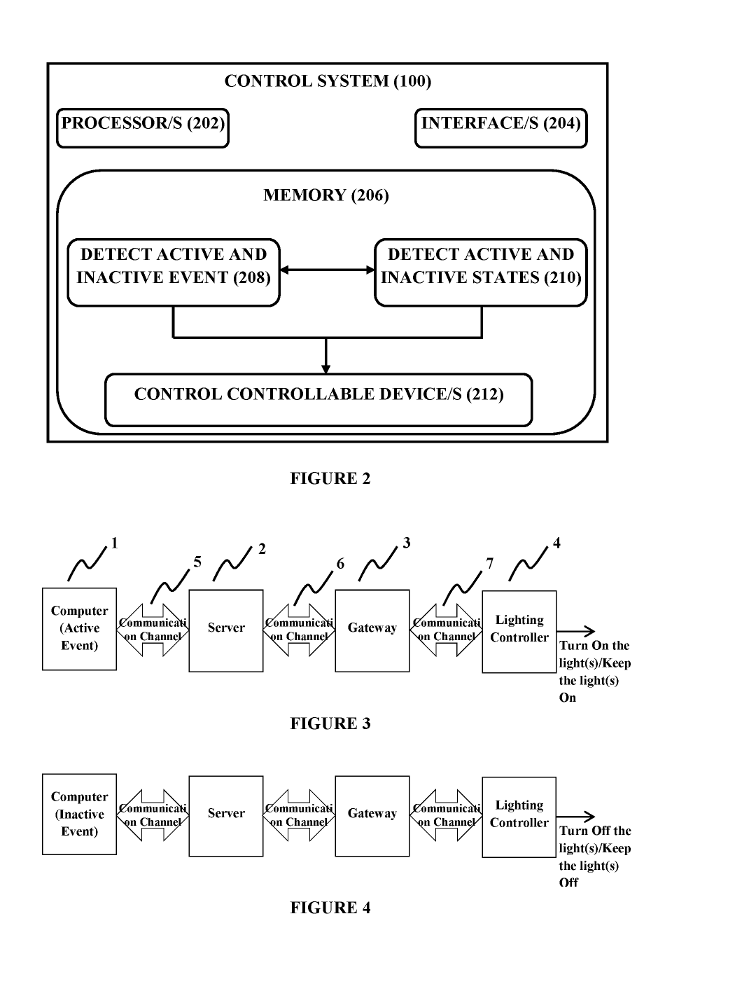

Referring now to FIG. 2 illustrates a control system (100) with processor (202), an interface (204) and a memory (206) for controlling one or more controllable devices as shown, in accordance with an embodiment of the present subject matter.

In one implementation, a control system (100) for controlling one or more controllable devices is disclosed. The control system (100) comprises of a memory (206) for storing a plurality of instructions and a processor (202) operatively coupled to the memory (206). The processor (202) is configured to: detect at least one of active or inactive event on one or more electronic or electrical device (208); and one or more electronic or electrical device's transition between at least one of an active or inactive states (210); and to control (212) one or more controllable device, based on at least one of active or inactive event detected on one or more electronic or electrical device and one or more electronic or electrical device's transition between at least one of an active or inactive states detected.

In one implementation, the active or inactive event on the one or more electronic or electrical device may be selected from a group comprising pressing a specific key, pressing a combination of specified multiple keys, computer events and interrupts associated with the electronic or electrical devices including augmented reality devices similar to Google Glass®, wearable electronics, smart watches and other virtual reality devices, biometric identification, RFID identification, or identification through any other sensors or mechanisms or any combination thereof. In one example, the computer events may be but not limited to controlling working of the electronic or electrical device using some software application installed on it that may include but not limited to team viewer and the like. Further, the computer events may also include automatically or manually controlling the electronic or electrical device using a mobile phone or Bluetooth attached to them using through some software application or controlling through any other devices connected to the electronic or electrical device either through wired or wireless or combination of any wired and wireless mechanisms.

In one implementation, the at least one of active or inactive event detected and one or more electronic or electrical device's transition between at least one of an active or inactive states indicates that said one or more user would like to at least activate, deactivate and adjust the one or more controllable devices.

In one implementation, the at least one of active or inactive event detected and the one or more electronic or electrical device's transition between the at least one of an active or inactive states is caused by the user.

In one implementation, the at least one of active or inactive event detected and the one or more electronic or electrical device's transition between the at least one of an active or inactive states is caused through an automatic scheduled activity of the one or more electronic or electrical device.

In one implementation, when the active event occurs the one or more electronic or electrical device is said to be in the active state.

In one implementation, when the inactive event occurs the one or more electronic or electrical device is said to be in the inactive state.

In one implementation, the at least one of active or inactive event detected on one or more electronic or electrical device and the one or more electronic or electrical device's transition between the at least one of an active or inactive states controls the one or more controllable device corresponding to a location of one or more electronic or electrical device.

In one implementation, on detecting the at least one of active or inactive event and the one or more electronic or electrical device's transition, the one or more electronic or electrical device is configured to send at least one message related to the at least one of active or inactive event detected and the one or more electronic or electrical device's transition between the at least one of an active or inactive states to one or more other device which is further configured to communicate the at least one message to the controlling one or more controllable device.

In one implementation, a method for controlling one or more controllable device, based on at least one of active or inactive event detected on one or more electronic or electrical device and one or more electronic or electrical device's transition between at least one of an active or inactive states is disclosed. In one implementation, the method may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

In one implementation when controlling the lighting corresponding to the user computer terminal based on the user activity on his computer, when an Inactive event happens, the idle time for which there is no detected user activity on user computer before sending signal to turn off the light can be decreased to a predetermined value. Similarly, when an Active event happens, the idle time for which there is no detected user activity on user computer before sending signal to turn off the light can be increased to a predetermined value.

The order in which the method is described is not intended to be construed as a limitation, and any number of the described method blocks can be combined in any order to implement the method or alternate methods. Additionally, individual blocks may be deleted from the method without departing from the protection scope of the subject matter described herein. Furthermore, the method can be implemented in any suitable hardware, software, firmware, or combination thereof. However, for ease of explanation, in the embodiments described below, the method may be considered to be implemented in the above control system (100).

In one implementation, the controllable devices may be devices and/or applications within the controlled or monitored environment. Such devices and/or applications may include, but are not limited to, communications equipment (such as, telephones, intercoms, etc.), entertainment systems (such as, televisions, CD/DVD players, gaming applications, stereos, etc.), monitoring systems (such as, security cameras, baby monitors, etc.), safety/security systems (such as, fire alarms, sprinkler systems, Locks on doors or windows, etc.), personal computers (such as, desktops, notebooks, notepads, personal digital assistants, etc.), cooking appliances (such as, ovens, coffee makers, electrical food/beverage warmers, etc.), comfort systems (such as, heating and air conditioning (HVAC), humidifiers, dehumidifiers, air purifiers, light switches, light dimmers, etc.), power outlets, power supplies, and/or the like.

In one implementation, although the present invention is explained considering that it is implemented control system (100) for controlling one or more controllable devices, it may be understood that the present invention may also be implemented in a variety of computing systems, such as a laptop computer, a desktop computer, a notebook, a workstation, a mainframe computer, a server, a network server, and the like. It will be understood that the control system (100) may be accessed by multiple users (not shown in figure), or applications residing on the electronic or electrical device (not shown in figure). Examples of the electronic or electrical device may include, but are not limited to, a portable computer, a personal digital assistant, a handheld device, and a workstation. The electronic or electrical device may be communicatively coupled to one or other devices used by users using a network (108).

In one implementation, the network or the communication channel used for communicating between the controllable devices and monitored devices may be a wireless network, a wired network or a combination thereof. The network can be implemented as one of the different types of networks, such as intranet, local area network (LAN), wide area network (WAN), the internet, optic fiber network, infrared, Bluetooth, ZigBee and the like. The network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network may include a variety of network devices, including routers, bridges, servers, computing devices, storage devices, and the like.

In one implementation, the control system (100) comprises of a memory (206) for storing a plurality of instructions and a processor (202) operatively coupled to the memory (206). The system may also include a user interface (204) or interface/s may include a variety of software and hardware interfaces, for example, a web interface, a graphical user interface, and the like. The user interface (204) may allow the users to interact with system (100) directly or through the other devices. Further, the user interface may enable the system (100) to communicate with other the electronic or electrical device, such as web servers and external data servers. The user interface may facilitate multiple communications within a wide variety of networks and protocol types, including wired networks, for example, LAN, cable, optical fiber etc., and wireless networks, such as WLAN, cellular, infrared, Bluetooth, or satellite. The I/O interface may include one or more ports for connecting a number of devices to one another or to another server.

In one implementation, the system (100) may be implemented as one or more microprocessors, microcomputers, microcontrollers, digital signal processors, central processing units, state machines, logic circuitries, and/or any devices that manipulate signals based on operational instructions. Among other capabilities, the processor (202) or the CPU of the specialized electronic or electrical card reader device (not shown) is configured to fetch and execute computer-readable instructions stored in the memory (not shown).

In one implementation, the memory (206) may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

In one implementation, the modules stored in the memory include routines, programs, objects, components, data structures, etc., which perform particular tasks or implement particular abstract data types. In one implementation, the modules may include programs or coded instructions that supplement applications and functions of the system (100).

### Working Examples

(Person skilled in the art will understand that the working example shall not limit the scope of invention but is provided to understand the invention in easy manner.):

Referring now to FIG. 3 illustrates a computer/group of computers that share one or more lights in workplace wherein active events happen on the user computer and lights corresponding to the user computer are tuned on as shown, in accordance with an embodiment of the present subject matter.
1. A computer/group of computers that share one or more lights in workplace
2. A server configured to receive messages from one or more computers and which in turn communicates with communication protocol gateway or lighting controller to turn On/Off lights corresponding to the user computer.
3. Gateway is any protocol gateway or bridge that helps to connect the Server and Lighting Controller. For e.g. if Communication channel 6 runs on LAN network and Lighting controller runs on Zigbee protocol, then Gateway acts as a bridge between LAN and Zigbee Network.
4. Lighting Controller turns On/Off one or more lights corresponding to the computer/group of computers mentioned in 1.
5,6,7 are wired or wireless communication channels/networks that can use various protocols viz. Ethernet, Wifi, Infrared, RF, Microwave, optic fiber etc. or any other means of communication/signaling.

Referring now to FIG. 4 illustrates a computer/group of computers that share one or more lights in workplace wherein inactive events happen on the user computer and lights corresponding to the user computer are tuned off as shown, in accordance with an embodiment of the present subject matter. In one implementation, the similar system as mentioned in FIG. 3 except that Inactive events happen on the user computer and lights corresponding to the user computer are tuned off.

1. FIG. 3 discusses one form of the proposed invention, wherein happening of Active event on the Computer (1) is communicated to the server (2) which again transmits the message to lighting controller (4) through protocol gateway (3). The lighting controller will then turn on the light(s) corresponding to the user's computer terminal.
2. In FIG. 4 happening of Inactive event on the Computer is communicated to the server which again transmits the message to lighting controller through protocol gateway. The lighting controller will then turn off the light corresponding to the user's computer terminal.
3. On occurrence of Inactive events, user computer or server or lighting controller may wait for a small buffer time before actually turning off the light corresponding to the user computer. This is just to give sufficient time for user to completely move away from his workplace. Once the Inactive event is triggered, a timer is turned on and on expiry of timer the state of the computer is checked again. If the system is not in Active state, light will be switched off otherwise, light will remain on. The timer can be implemented in user computer or server or lighting controller as per the convenience.
4. It may be noted and understood that this system can be implemented in multiple ways by controlling lighting based on Active/Inactive events on the user computer. For e.g. in other forms of the invention, user computer directly communicates (over any communication channels between the computer and lighting controller) with lighting controller without either server or protocol gateway in between them.

In one implementation, a server or lighting controller unit will periodically keep monitoring the user computer or the electronic or electrical device to see whether it is in Active/Inactive state over the communication channels. In case if user computer is in Inactive state (i.e. no response received after pinging it); a timer is turned on to turn off the light on its expiry. After expiry of timer, state of user computer is monitored again. If it is still in Inactive state, lighting controller will turn off the light or if server is present, it signals the lighting controller to turn off the light.

In one implementation, where multiple users are sharing one or more lights/electrical loads etc, the server or lighting controller will monitor the state of all the computers/electronics/electrical devices under multiple users that share one or more lights/electrical loads before deciding to turn on/off one or more lights shared by a group of users. This is because, if a multiple users are sharing one or more lights and if one of the user moves away from his workplace, then state of the computers/electronics/electrical devices of the other users in that group need to be checked before turning off the lights. If any of the other computers in the group is still in Active state, the lights should remain on.

In one implementation, above it is explained how to control lighting by monitoring Active/Inactive events, it may be noted, that the same functionality can be implemented indirectly in many ways including:
a. Triggering linked events after the occurrence of Active/Inactive events and monitoring the linked events/states instead of Active/Inactive events mentioned above and deciding to turn On/Off the lights. For e.g. if computer is configured to turn off the display (immediately or after predetermined amount of idle time which is different than the display turnoff schedule when computer is in Unlocked state) when computer is Locked, then display turn off can be taken as trigger input to turn off the lights at the location of the user computer. In this way there may be a nested linking of multiple events to Active/Inactive events discussed in this specification which can be monitored to turn On/Off the lights.
b. Instead of immediately acting after the happening of Active/Inactive events the happenings of Active/Inactive states will be recorded first. The recorded data or computer state is periodically monitored and lighting systems are controlled accordingly. For e.g. if the computer is Locked (which is regarded as occurrence of Inactive event) then instead of immediately sending the message to turn off the light, the happening of Lock event is recorded. This will be noticed during periodic monitoring of the recorded data or state of the computer and appropriate action is initiated to turn off the lights.
c. Any combination of a and b mentioned above may be also possible.

In one implementation, user might remotely connect to the computer other than from the location of the user's computer terminal in workplace. So, while sending the message to turn on the lights and/or similar devices apart from checking for the Active/Inactive events/states etc. the location of the user will be determined and lights will be turned on only if user is present in his workplace.

In one implementation, a single user computer comprises a single computer with multiple terminals to simultaneously support multiple users. In this case, the location of the user terminal also will be sent along with the light on/off message to the lighting controller or server.

In one implementation, user may override the functionality of the system to keep the light and/or similar devices corresponding to the computer terminal turned on even if user computer is taken into Inactive state. The override can be implemented in multiple ways as given below:
1. Button (in user's computer or mobile phone or IP/land line phone) or switch to keep the lights on for the specified duration irrespective of the state of the computer.
2. Any specific key on key board or combination of keys on pressing which light is turned on for a specified duration. Or signaling thorough other peripheral devices connected to the user's computer.
3. A telephone call to a specified number that keeps the light corresponding to user's computer turned on for specified duration
4. Detection of user presence through Occupancy Sensor which can be located anywhere on ceiling, walls, desk, laptop or phone
5. Any other mechanism

Apart from above mentioned features and advantages of the control system and method thereof, the other functionalities, features, advantages are as given below but not restricted to it:

In one implementation, a light and/or similar devices can be turned Off/On it is also understood that, it can also be Dimmed/brightened (dimming the light or setting a predetermined color and brightness to the light/sending appropriate control signals to load/control circuits).

In one implementation, in few case of certain light bulbs (like CFL lamps), it is recommended to keep the light ON at least for a specified duration of time and avoid frequent switching. So whenever a light is being turned off it is ensured that it is ON for the minimum specified time.

It may be understood by the person skilled in the art that more things can be done by using the system (100) with a single action or event/state detected. For example, if a light is being turned off when computer is Locked, then Air cooling in the room can also be slightly reduced corresponding to the power consumed by the light and computer display (in case if display is configured to turn off immediately/faster after Locking the computer along with the light). In one implementation, whenever a computer or light or any electrical equipment is turned off the electricity consumed comes down. Similarly whenever a computer or light is turned ON the electricity consumed increases. The electricity consumed is finally released as heat inside the room. This released heat has to be evacuated by the HVAC systems.

Usually, HVAC in offices is controlled by inputs from temperature sensors. However, temperature sensors may not be sensitive enough to detect minor changes in the heat release. For example in a large office with hundreds of computers, a temperature sensor may not be able to detect differences in heat release due to turning On/Off of a single computer or light. So whenever an Inactive event happens (and a light or a computer display is turned off or computer is turned off or put in a low power state) a message is transmitted to the server or controller to decrease the cooling corresponding the power consumed by light or computer display or computer and whenever an active event happens a message can be transmitted to increase the cooling corresponding the power consumed by light or computer display or computer. The scope of this system (100) can be easily extended to mobile phones, tablets, printers and other electronic or electrical equipment as well. In a mobile phone or tablet or in some computers whenever screen is Locked, screens are usually turned off immediately thereby saving the power. Apart from saving power by turning off the display, the cooling of the air conditioner can also be reduced correspondingly (usually a fraction of the rated power of display) to save power consumed by the air conditioner. Similarly if a user is speaking on a phone, cooling in the room is slightly increased corresponding to the marginal increase in power consumed by phone. And when phone is idle, cooling is reduced. Hence HVAC is controlled from the level of usage of any electronic or electrical equipment. This way of marginal increase/decrease in the heating/cooling of HVAC systems can be accomplished in multiple ways including the usage of Variable Frequency Drives (VFD).

In case of HVAC systems controlled by the Occupancy Sensors, whenever an occupancy is detected, cooling is increased (or AC is turned On) and vice versa. However, occupancy sensor systems will not be able to count how many people are occupying the space under its purview. The heat released by human body need to be emptied by the air conditioners. So, if more people are there more cooling needs to be generated and vice versa. So, whenever a particular user presence is detected in a room through swipe In/Out of access cards, biometric identification of the user during entry/exit of the rooms or biometric login/user identification on computers or by any other method, the cooling is marginally increased to compensate for extra heat released from a human body and vice versa.

In one implementation, a brief illustration of controlling the Air conditioner based on Active or inactive events is as follows:

On the occurrence of Inactive Events along with turning off or dimming the light the cooling corresponding to power consumed by the light can also be decreased.

On the occurrence of Active Events along with turning on or brightening the light the cooling corresponding to power consumed by the light can also be increased.

In case if HVAC is heating the room instead of cooling then actions of Active or inactive events need to be reversed so that whenever a display or light is turned off, heating is increased and whenever a display or light is turned on heating is deceased.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description.

1. A control system for controlling one or more controllable device, the control system comprises:
a first means for detecting at least one active or inactive event on one or more electronic device, wherein the one or more electronic device transition between at least one of an active or inactive states; and
a second means for controlling one or more controllable device, based on the at least one active or inactive event detected on the one or more electronic device and the one or more electronic device transition between at least one of an active or inactive states detected.

2. The control system of claim 1, wherein the control system further comprises: memory for storing a plurality of instructions; and a processor operatively coupled to the memory, wherein the processor is configured to detect the at least one active or inactive event on the one or more electronic device, and the one or more electronic device's transition between at least one of an active or inactive states, and the processor is configured to control the one or more controllable device, based on the at least one active or inactive event detected on the one or more electronic device and the one or more electronic device's transition between at least one of an active or inactive states detected.

3. The control system of claim 1, wherein when one or more users are sharing the one or more controllable devices, the state of the one or more electronic device under different users sharing the one or more controllable devices are monitored for controlling the one or more controllable devices.

4. The control system of claim 1, wherein the active or inactive event on the one or more electronic device is selected from a group comprising pressing a specific key, pressing a combination of specified multiple keys, computer events and interrupts associated with the one or more electronic device, biometric identification, RFID identification, or identification through other sensors or mechanisms.

5. The control system of claim 1, wherein the at least one of active or inactive event detected and the one or more electronic device's transition between the at least one of an active or inactive states is caused by the one or more users or through an automatic scheduled activity of the one or more electronic device.

6. The control system of claim 1, wherein the at least one of active or inactive event detected on the one or more electronic device and the one or more electronic device's transition between the at least one of an active or inactive states controls the one or more controllable device corresponding to a location of one or more electronic device.

7. The control system of claim 1, wherein on detecting the at least one of active or inactive event and the one or more electronic device's transition between the at least one of an active or inactive states, the one or more electronic device is configured to send at least one message related to the at least one of active or inactive event detected, and the one or more electronic device's transition between the at least one of an active or inactive states, to one or more other electronic device, which is configured to communicate the at least one message for controlling one or more controllable device.

8. The control system of claim 1, wherein the amount of time during which there is no detected user activity on the one or more electronic device considered for controlling the one or more controllable device is different in active and inactive states.

9. The control system of claim 1, wherein the controlling of one or more controllable device(s) is overridable.

10. A method for controlling one or more controllable device, the method comprising: detecting at least one active or inactive event on one or more electronic device;
detecting one or more electronic device's transition between at least one of an active or inactive states;
controlling one or more controllable device based on the at least one of active or inactive event detected on the one or more electronic device; and transitioning between at least one of an active or inactive states detected.

11. The method of claim 10, wherein when one or more users are sharing one or more electrical loads, the state of the one or more electronic device under different users sharing one or more electrical loads are monitored for controlling one or more electrical loads.

12. The method of claim 10, wherein the active or inactive event on the one or more electronic device is selected from a group comprising pressing a specific key, pressing a combination of specified multiple keys, computer events and interrupts associated with the one or more electrical device, biometric identification, RFID identification, or identification through other sensors or mechanisms or any combination thereof.

13. The method of claim 10, wherein the at least one active or inactive event detected and the one or more electronic device's transition between the at least one of an active and inactive states is caused by the user of the one or more electronic device.

14. The method of claim 10, wherein the at least one active or inactive event detected and the one or more electronic device's transition between the at least one of an active and inactive states is caused through an automatic scheduled activity of the one or more electronic device.

15. The method of claim 10, wherein the at least one active or inactive event detected on one or more electronic device and the one or more electronic device's transition between the at least one of an active and inactive states controls the one or more controllable device corresponding to a location of the one or more electronic device.

16. The method of claim 10, wherein detecting the at least one active or inactive event and the one or more electronic device's transition between the at least one of an active and inactive states, the one or more electronic device is configured to send at least one message related to the at least one active or inactive event detected and the one or more electronic device's transition between the at least one of an active and inactive states to the one or more electronic device which is further configured to communicate the at least one message to the controlling one or more controllable device.

17. The method of claim 10, wherein the active or inactive states of the one or more electronic device is determined through periodic monitoring of the one or more electronic device or periodic communication received from the one or more electronic device.

18. The method of claim 16, wherein the periodic monitoring interval and or periodic communication interval of current system state and occurrence of active or inactive events is different in active and inactive states.

19. The method of claim 10, wherein the amount of time during which there is no detected user activity on the one or more electronic device considered for controlling the one or more controllable device is different in active and inactive states.

20. The method of claim 19, wherein the user activity is selected from a group comprising physical usage of the one or more electronic device or a peripherals or device connected to the one or more electronic device.

21. The control system as claimed in any of the preceding claims, wherein the at least one of active or inactive event detected and one or more electronic or electrical device's transition between at least one of an active or inactive states indicates that said one or more users would like to at least one activate, deactivate, and adjust the one or more controllable devices.

22. The control system as claimed in any of the preceding claims comprise of programmable logic controllers, relays, regulators, variable frequency drives or any other mechanism or any combination thereof for controlling one or more controllable device.
